(19) United States
(12) Patent Application Publication
(10) Pub. No.: US 2023/0106179 A1
(43) Pub. Date: Apr. 6, 2023

(54) METAL-ORGANIC FRAMEWORK MATERIAL-BASED FUELS AND METHODS OF USE THEREOF

(71) Applicant: ACSYNAM INC., St-Leonard (CA)

(72) Inventors: Cristina Mottillo, Terrebonne (CA); Hatem M. Titi, Montreal (CA)

(21) Appl. No.: 17/960,315

(22) Filed: Oct. 5, 2022

Related U.S. Application Data
(60) Provisional application No. 63/252,640, filed on Oct. 6, 2021.

(51) Int. Cl. C06B 41/00; F02K 9/42; F02K 9/97

(52) U.S. Cl. CPC C06B 41/00; F02K 9/425; F02K 9/97

(57) ABSTRACT

An ignitable and energetic metal-organic framework material for producing a fuel when exposed to an ignition source, comprising a general structure M1-L-M2, wherein L is an organic linker comprising one or more nitro substituents, and wherein M1 and M2 are same or different metal cations.

The present application claims priority from U.S. Provisional Patent Application No. 63/252,640 with a filing date of Oct. 6, 2021, incorporated herein by reference.

### TECHNICAL FIELD

The present disclosure relates to fuels, and more particularly to fuels including ignitable metal-organic framework materials.

### BACKGROUND

Energetic materials are a class of compounds with applications in space propulsion, insensitive munitions, explosives, gas generators, among others. They are generally characterized by high amounts of stored chemical energy that can be released in a controlled manner upon exposure to certain triggers including heat, light, mechanical force, electrical stimulus, or contact with a chemical oxidizer. Most commonly used energetic materials for space propulsion or munitions include fuels such as hydrazine, ammonium perchlorate composites, kerosene/oxygen mixtures, or explosives such as RDX, HMX, and CL-20. The discovery and development of new energetic materials as fuels or propellants for rockets or insensitive unitions is challenging due to the delicate balance between performance, functionality, and chemical sensitivity, i.e. some new materials have interesting properties but not enough energy, and some of the most effective energetic materials are also the most sensitive. This can lead to lack of performance and/or adequate performance but unwanted ignition.

Most searches for new energetic materials to be used as propellants or fuels thus focus on increasing performance, i.e. energy density, combustion characteristics, higher fuel efficiency, while maintaining enough stability for use in the field. Ionic liquids, co-crystals, salts, cellulose derivatives, and more recently, metal-organic frameworks, have been investigated as new potential components in propellant formulas and explosive mixtures.

Metal-organic frameworks (MOFs) are a class of inorganic polymers composed of metal cations and inorganic linkers that combine to form molecular frameworks, often with open pores that can accommodate guests such as gas molecules, solvent molecules, or even solid compounds. The large variety of MOF building blocks available has led to tens of thousands of MOF structures being reported in the academic and patent literature. However, the design of MOFs to meet very specific physical, chemical, and technical requirements for a particular application is a challenge. This is especially true for MOFs as they pertain to new energetic materials. Recent academic and patent literature has revealed that MOFs can store significant chemical energy, can be rendered hypergolic (combust upon contact with an oxidizer), and can hold energetic guests to increase their chemical and thermal stability. For use in rocket propellants and fuels, however these MOFs either have too low heat or gas output to significantly increase the performance of the rocket.

MOFs provide a unique platform whose modularity allows for at least multiple, properties to be modified and optimized. In a way, MOFs are an advantageous system to achieve the goal of having a material where at least several properties can be modified. It is therefore important to design new MOFs that have most, not just some, of the advantageous characteristics necessary to increase the performance of rocket fuels, propellants, and related technologies.

### SUMMARY

The present disclosure relates to metal organic framework materials for use as propellants and/or fuels that provide an increased output of heat and gas.

MOFs include metal cations (nodes) that are linked using an organic molecule (linker), or vice versa. The metal organic framework has a structure of metal cations coordinated to organic ligands. It has been discovered that employing an organic linker with a reduced carbon content and an increased nitrogen content yields a more performant fuel/propellant. This increase in nitrogen content is achieved by including one or more nitro-substituents to the organic linker.

A broad aspect is an ignitable and energetic metal-organic framework material for producing a fuel when exposed to an ignition source, including a general structure M1-L-M2, wherein L is an organic linker comprising one or more nitro substituents, and wherein M1 and M2 are same or different metal cations.

In some embodiments, M1 and M2 may each be divalent metal cations.

In some embodiments, M1 and M2 may each be selected from the group consisting of Co²⁺, Zn²⁺, Cd²⁺, Fe²⁺, Ni²⁺, Ag²⁺ and Cu²⁺.

In some embodiments, M1 and M2 may each be Co²⁺.

In some embodiments, M1 and M2 may each be Zn²⁺.

In some embodiments, M1 and M2 may each be Cd²⁺.

In some embodiments, the organic linker may be an organic azolate linking moiety.

In some embodiments, organic azolate linking moiety may be selected from the group consisting of imidazolate, 1,2,4-triazolate, 1,2,3-triazolate, tetrazolate and pyrazolate.

In some embodiments, the organic azolate linking moiety may be imidazolate.

In some embodiments, a nitro substituent may be located at the 2-position of said imidazolate.

In some embodiments, a nitro substituent may be located at the 4-position of said imidazolate.

In some embodiments, nitro substituents may be located at the 2- and 4-positions of said imidazolate.

In some embodiments, nitro substituents may be located at the 2-, 4-, and 5-positions of said imidazolate.

In some embodiments, the imidazolate may be unsubstituted or substituted in one or more of the 2-, 4- and 5- positions.

In some embodiments, the organic azolate linking moiety is benzimidazolate, wherein the benzimidazolate may be unsubstituted, substituted at the 2-position or in one or more of the phenyl rings.

In some embodiments, the organic azolate linking moiety may be 1,2,3-triazolate that is unsubstituted or substituted in one or more of the 4- and 5-positions.

In some embodiments, the organic azolate linking moiety may be 1,2,4-triazolate that is unsubstituted or substituted in one or more of the 3- and 5-positions.

In some embodiments, the organic azolate linking moiety may be tetrazolate that is unsubstituted or substituted in the 5-position.

In some embodiments, the organic linker may be an organic conjugate base derived from:

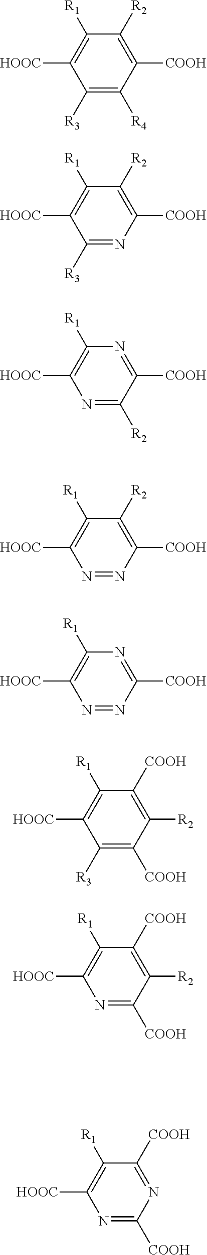

or a combination thereof.

In some embodiments, the metal organic framework material may exhibit ignition upon contact with an ignition source selected from: heat, electrical charge, or mechanical force.

Another broad aspect is use of an ignitable metal-organic framework material as defined herein for producing a fuel when said metal-organic framework ignites upon contact with an ignition source, wherein the ignition occurs by subjecting said metal-organic framework to one or more of heat, electrical charge, and mechanical force.

Another broad aspect is an ignitable metal-organic framework material comprising a general structure M1-L-M2, wherein L is an imidazolate linking moiety comprising a nitro substituent at the 2-position, wherein M1 and M2 are same or different metal cations, and wherein M1 and M2 are selected from the group consisting of Zn²⁺, Co²⁺, and Cd²⁺.

In some embodiments, a substituent at the 4-position of said imidazolate linking moiety may be selected from the group consisting of H, loweralkyl, oxyalkyl, aryl, heteroaryl, heterocycloalkyl, aminoalkyl and a halogen.

In some embodiments, a substituent at the 5-position of said imidazolate linking moiety may be selected from the group consisting of H, loweralkyl, oxyalkyl, aryl, heteroaryl, heterocycloalkyl, aminoalkyl and a halogen.

Another broad aspect is an ignitable metal-organic framework material comprising a general structure M1-L-M2, wherein L is an imidazolate linking moiety comprising substituents at the 2- and 4-positions, wherein said substituents are nitro, wherein M1 and M2 are same or different metal cations, and wherein M1 and M2 are selected from the group consisting of Zn²⁺, Co²⁺, and Cd²⁺.

In some embodiments, a substituent at the 5-position of said imidazolate linking moiety may be selected from one of H, loweralkyl, oxyalkyl, aryl, heteroaryl, heterocycloalkyl, aminoalkyl and a halogen.

Another broad aspect is an ignitable metal-organic framework material comprising a general structure M1-L-M2, wherein L is an imidazolate linking moiety comprising a substituent at the 2-, 4-, and 5-positions, wherein said substituent is nitro, wherein M1 and M2 are same or different metal cations, and wherein each of M1 and M2 is selected from the group consisting of Zn²⁺, Co²⁺, and Cd²⁺.

In some embodiments, each of M1 and M2 may be Zn²⁺.

In some embodiments, each of M1 and M2 may be Co²⁺.

Another broad aspect is use of an ignitable metal-organic framework material as defined herein for producing a fuel when said metal-organic framework ignites upon contact with an ignition source, wherein the ignition occurs by subjecting said metal-organic framework to one or more of heat, electrical charge, and mechanical force.

Another broad aspect is a combustible composition comprising an ignitable metal-organic framework material, a combustible substance and an additive, wherein the metal-organic framework material is for producing a fuel when ignited upon contact with an ignition source, the metal-organic framework material comprising a general structure

M1-L-M2, wherein L is an aromatic linker comprising one or more nitro substituents, and wherein M1 and M2 are same or different metal cations.

In some embodiments, the general structure of the metal-organic framework material may be Zn(Nlm)₂, Co(Nim)₂, Cd(Nim)₂, Zn(diNlm)₂, Co(diNim)₂, Cd(diNim)₂, Zn(triNlm)₂, Co(triNim)₂, or Cd(triNim)₂.

In some embodiments, the combustible substance may be a metal or metalloid powder.

In some embodiments, the combustible substance may be a metal or metalloid powder selected from at least one of Al(0), Mg(0), Zn(0), Zr(0), Ti(0), W(0), and Si(0).

In some embodiments, the combustible substance may be an inorganic compound.

In some embodiments, the combustible substance may be an inorganic compound selected from at least one of the groups consisting of boranes, decaborate anions, hydrides, sulfides, hydrazine, hydrazine derivatives, inorganic salts, and peroxides.

In some embodiments, the combustible substance may be an inorganic compound selected from the group consisting of decaborane, hydrazine and aluminum hydride.

In some embodiments, combustible substance may be an organic compound.

In some embodiments, the combustible substance may be an organic compound with at least one functional group selected from the group consisting of cyano, nitro, amino, alkyl, alkynyl, butadienyl, phenyl, halides, hydroxyl, carbonyl, peroxy, acetylene, ethylene and vinyl.

In some embodiments, the combustible substance may be an organic compound selected from the group consisting of paraffin, kerosene and nitroglycerin.

In some embodiments, the combustible substance may be a polymeric compound.

In some embodiments, the polymeric compound may be selected from one or more of the groups consisting of polyesters, polysulfides, polyurethanes, resins, nitrates, and rubbers.

In some embodiments, the polymeric compound may be selected from the group consisting of hydroxylterminated polybutadiene, polyethylene, polystyrene and polybutadiene acrylonitrile.

In some embodiments, the additive may serve as a catalyst or initiator.

In some embodiments, the additive may include one or more metals.

In some embodiments, the one or more metals may be selected from at least one of Ti(0), Al(0), Pd(0), and Zr(0).

In some embodiments, the additive may be one or more inorganic compounds.

In some embodiments, the one or more inorganic compounds acting as the additive may be selected from the group consisting of hydrides, azides, cyanamides, nitrates, acetates, sulfates, perchlorates, peroxides, oxides, and picrates.

In some embodiments, the one or more inorganic compounds acting as the additive may be selected from the group consisting of ammonium nitrate, ammonium dinitramide, ammonium perchlorate, and aluminum borohydride.

Another broad aspect is a combustible material comprising a metal-organic framework material for producing a fuel when subjected to an ignition source, comprising a general structure M1-L-M2, wherein L is an aromatic linker comprising one or more nitro substituents, and wherein M1 and M2 are same or different metal cations, and wherein the metal-organic framework includes pores containing one or more guests.

In some embodiments, the metal-organic framework may be Zn(Nlm)₂, Co(Nim)₂, Cd(Nim)₂, Zn(diNlm)₂, Co(diNim)₂, Cd(diNim)₂, Zn(triNlm)₂, Co(triNim)₂, or Cd(triNim)₂.

In some embodiments, the guest may be a metal or metalloid powder.

In some embodiments, the guest may be a metal or metalloid powder selected from at least one of Al(0), Mg(0), Zn(0), Zr(0), and Si(0).

In some embodiments, the guest may be an inorganic compound.

In some embodiments, the inorganic compound acting as a guest may be selected from one or more groups consisting of hydrides, azides, cyanamides, nitrates, acetates, sulfates, perchlorates, peroxides, oxides, and picrates.

In some embodiments, the inorganic compound acting as a guest may be selected from the group consisting of ammonium nitrate, ammonium perchlorate and aluminum borohydride.

In some embodiments, the guest may be an organic compound.

In some embodiments, the organic compound acting as a guest may include at least one functional group selected from the group consisting of cyano, nitro, amino, alkyl, alkynyl, butadienyl, phenyl, halides, hydroxyl, carbonyl, peroxy, acetylene, ethylene and vinyl.

In some embodiments, the guest may be an organic compound selected from the group consisting of paraffin, kerosene, and nitroglycerin.

In some embodiments, the guest may be an additive or a combustible substance.

Another broad aspect is a method of producing a combustible composition, the method including adding at least one of a combustible substance and an additive to an ignitable metal-organic framework material, wherein the metal-organic framework material is for producing a fuel when subjected to an ignition source, the metal-organic framework material comprising a general structure M1-L-M2, wherein L is an aromatic linker comprising one or more nitro substituents, and wherein M1 and M2 are same or different metal cations.

Another broad aspect is a combustible composition, comprising an ignitable metal-organic framework material, and further comprising at least one of a combustible substance and an additive, wherein the metal-organic framework material is for producing a fuel when subjected to an ignition source, the metal-organic framework material comprising a general structure M1-L-M2, wherein L is an aromatic linker comprising one or more nitro substituents, and wherein M1 and M2 are same or different metal cations.

Another broad aspect is a method of propelling a missile or rocket, including combusting a metal organic framework material through exposure to an ignition source, the metal-organic framework material comprising a general structure M1-L-M2, wherein L is an aromatic linker comprising one or more nitro substituents, and wherein M1 and M2 are same or different metal cations, wherein the combusted metal organic framework produces nitrogen dioxide as a combustion by-product.

Another broad aspect is a method of fuelling a drilling system for deep-sea oil and gas extraction, including combusting a metal organic framework material through exposure to an ignition source, the metal-organic framework material comprising a general structure M1-L-M2, wherein L is an aromatic linker comprising one or more nitro substituents, and wherein M1 and M2 are same or different metal cations, wherein the combusted metal organic framework drives the drilling system for deep-sea oil and gas extraction.

Another broad aspect is a rocket, including an elongated hollow body with an exit point for allowing heated combustion fluid to exit the hollow body; a propelling nozzle joined to the exit point, where the combustion fluid flows from the elongated hollow body to the propelling nozzle through the exit point, for expanding and accelerating the combustion gases, for creating a thrust for the rocket; a metal-organic framework material, contained in the elongated hollow body, comprising a general structure M1-L-M2, wherein L is an aromatic linker comprising one or more nitro substituents, and wherein M1 and M2 are same or different metal cations; and an ignition source for igniting the metal-organic framework material.

In some embodiments, the ignition source may be flame-based.

In some embodiments, the metal-organic framework material may be positioned in the hollow body to define a hollow cavity for receiving the combustion fluid and channeling the combustion fluid to the exit point.

Another broad aspect is an ignitable and energetic pillared-type metal-organic framework material for producing a fuel when exposed to an ignition source, comprising the general structure L1-MC1-L2-MC2, wherein L1 is an organic linker comprising no, or one or more nitro substituents, and L2 is a pillaring linker with no, or one or more nitro substituents, and MC1 and MC2 are same or different paddlewheel type metal units.

In some embodiments, each of MC1 and MC2 may include metal ions selected from the group consisting of Co²⁺, Zn²⁺, Cd²⁺, Fe²⁺, Ni²⁺, Ag²⁺ and Cu²⁺.

In some embodiments, L1 may be a carboxylate bridging linker.

In some embodiments, the carboxylate bridging linker may be selected from the group consisting of terephthalate, biphenyl-4,4′-dicarboxylate, p-terphenyl-4,4″-dicarboxylate, 1,4- or 2,6-naphthalenedicarboxylate, fumarate, squarate, and their derivatives.

In some embodiments, L2 may be a carboxylate bridging linker.

In some embodiments, L2 may be selected from the group consisting of 1,4-diazabicyclo[2.2.2]octane), pyrazine, 4,4′-dipyridyl, terpyridyl, and their derivatives.

Another broad aspect is an ignitable and energetic UiO-type metal-organic framework material for producing a fuel when exposed to an ignition source, comprising the general structure MC1-L-MC2, wherein L is an organic linker comprising one or more nitro substituents, and MC1 and MC2 are same or different metal clusters.

In some embodiments, the organic linker may be a carboxylate bridging linker with the one or more nitro substituents on the carboxylate bridging linker.

In some embodiments, the carboxylate bridging linker with the one or more nitro substituents on the carboxylate bridging linker may be selected from the group consisting of terephthalate, 1,4- or 2,6-naphthalenedicarboxylate and fumarate.

In some embodiments, the organic linker may be a carboxylate bridging linker selected from the ground consisting of terephthalate, biphenyl-4,4′-dicarboxylate, p-terphenyl-4,4″-dicarboxylate, 1,4- or 2,6-naphthalenedicarboxylate, fumarate, squarate, and their derivatives.

In some embodiments, each of MC1 and MC2 may include metal ions that are selected from the group consisting of Zr⁴⁺, Ti⁴⁺, and Hf⁴⁺.

Another broad aspect is an ignitable and energetic MIL-type metal-organic framework material for producing a fuel when exposed to an ignition source, including the general structure MC1-L-MC2, wherein L is an organic linker comprising one or more nitro substituents, and MC1 and MC2 are same or different metal clusters.

In some embodiments, each of MC1 and MC2 may include metal ions selected from the group consisting of Al³⁺, Fe³⁺ and Cr³⁺.

In some embodiments, L may be a carboxylate bridging linker.

In some embodiments, the carboxylate bridging linker may be selected from the group consisting of terephthalate, trimesate, biphenyl-4,4′-dicarboxylate, p-terphenyl-4,4″-dicarboxylate, 1,4- or 2,6-naphthalenedicarboxylate, fumarate, squarate, and their derivatives.

Another broad aspect is an ignitable and energetic isoreticular MOF-type metal-organic framework material for producing a fuel when exposed to an ignition source, including the general structure MC1-L-MC2, wherein L is an organic linker comprising one or more nitro substituents, and MC1 and MC2 are same or different metal clusters.

In some embodiments, each of MC1 and MC2 may include metal ions selected from the group consisting of Co²⁺, Zn²⁺, Cd²⁺, Fe²⁺, Ni²⁺, Mg²⁺, Ag²⁺ and Cu²⁺.

In some embodiments, L may be a carboxylate bridging linker selected from the group consisting of terephthalate, biphenyl-4,4′-dicarboxylate, p-terphenyl-4,4″-dicarboxylate, 1,4- or 2,6-naphthalenedicarboxylate, fumarate, squarate, and their derivatives.

Another broad aspect is an ignitable and energetic carboxylate-based metal-organic framework material for producing a fuel when exposed to an ignition source, comprising the general formula M1M2(L)(H₂O)₂·8H₂O, wherein L is an organic linker comprising one or more nitro substituents, and M1 and M2 are same or different metal ions.

In some embodiments, M1 and M2 may be each selected from the group consisting of Co²⁺, Zn²⁺, Cd²⁺, Fe²⁺, Ni²⁺, Ag²⁺ and Cu²⁺.

In some embodiments, L may be a carboxylate bridging linker.

In some embodiments, the carboxylate bridging linker may be selected from the group consisting of 2,4-dihydroxyterephthalate, 2-hydroxyterephthalate, 2,5-dihydroxybenzoate, and their derivatives.

Another broad aspect is an ignitable and energetic HKUST-type metal-organic framework material for producing a fuel when exposed to an ignition source, comprising the general structure MD1-L-MD2, wherein L is an organic linker comprising one or more nitro substituents, and MD1 and MD2 are same or different metal dimers.

In some embodiments, each of MD1 and MD2 may include metal ions selected from the group consisting of Co²⁺, Zn²⁺, Cd²⁺, Fe²⁺, Ni²⁺, Mg²⁺, Ag²⁺ and Cu²⁺.

In some embodiments, L may be a carboxylate linker.

In some embodiments, the carboxylate linker may be trimesate or its derivatives.

### BRIEF DESCRIPTION OF THE DRAWINGS

The invention will be better understood by way of the following detailed description of embodiments of the invention with reference to the appended drawings, in which:

FIG. 1 is a 3D representation of a structure of an exemplary metal organic framework material in accordance with the present teachings, where the organic linker has an exemplary nitro-substituent; and

FIG. 2 is a drawing of an exemplary rocket containing exemplary fuel with MOF materials.

### DETAILED DESCRIPTION

The present disclosure relates to materials used as fuels and/or propellants with an increased performance. More particularly, the present disclosure relates to metal organic framework materials for use as propellants and/or fuels, where the organic linker connecting the metal cations has one or more nitro-substituents. The MOF materials are ignitable and energetic. The MOF materials ignite when exposed to an ignition source, such as a flame, electricity, a mechanical force.

The metal organic framework has a repeating structure M1-L-M2, where M1 and M2 are metal cations, and L is an organic linker. For instance, an exemplary L-M1-L block of a metal organic framework in accordance with the present disclosure may be:

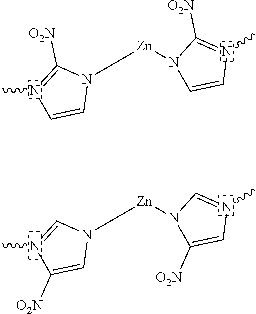

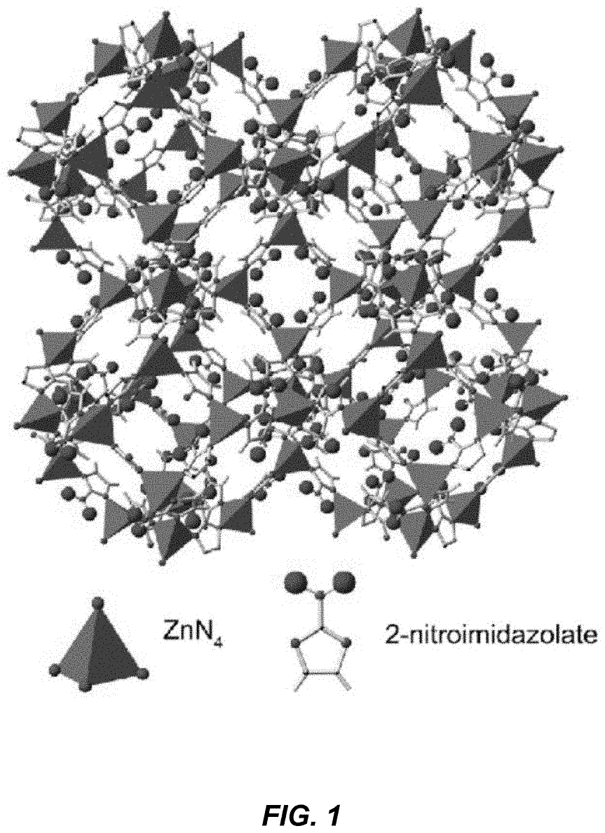

An exemplary representation of a metal organic framework is shown in FIG. 1. The structure of FIG. 1 is a lattice-like structure, where the structure includes pockets or pores. These pockets or pores can contain one or more guests. The guest may be an oxidizer or a reducer. Exemplary oxidizers include, but are not limited to liquid oxygen, ammonium nitrate, ammonium dinitramide, ammonium perchlorate, nitrous oxide, dinitrogen tetroxide, hydrogen peroxide, etc. Exemplary reducers include, but are not limited to liquid hydrogen, Al(0), hydroxyl-terminated polybutadiene, paraffin, kerosene, polyamides, etc.

In some embodiments, the guest may be a metal or metalloid powder.

In some embodiments, the guest may be metal or metalloid particles selected from at least one of Al(0), Mg(0), Zn(0), Zr(0), B(0), and Si(0).

In some embodiments, the guest may be an inorganic compound.

In some embodiments, the guest may be an inorganic compound selected from one or more groups consisting of hydrides, azides, cyanamides, nitrates, acetates, sulfates, perchlorates, peroxides, oxides, picrates, borohydrides, amides, dinitramides, borides, and carbides.

In some embodiments, the additive may be an inorganic compound such as ammonium nitrate, ammonium perchlorate, aluminum borohydride, or a molecule belonging to the class of boranes.

In some embodiments, the guest may be an organic compound.

In some embodiments, the guest may be an organic compound with at least one functional group selected cyano, nitro, amino, alkyl, allyl, vinyl, alkenyl, alkynyl, butadienyl, phenyl, halides, hydroxyl, carbonyl, peroxy and acetylene.

In some embodiments, the guest may be an organic compound is selected from paraffin, kerosene and nitroglycerin.

In some embodiments, the guest may be present in the metal-organic framework with a molar ratio anywhere from 0.1:0.9 to 0.9:0.1.

In some embodiments, the guest may be an additive or a combustible substance.

The guests can be added by introducing the guest during the synthesis of the metal organic framework and incorporating the guest in-situ. Alternatively, the pre-formed metal organic framework can be placed in an environment containing the guest, which then enters into the metal organic framework pores. This can be achieved, for example, by mixing the metal organic framework with the solid guest and putting the mixture at 45-75° C. to diffuse.

The organic nitro-substituted linker may be aromatic. Exemplary organic nitro-substituted linkers may include, but are not limited, one of the following, with one or more nitro-substituents: imidazolate, 1,2,4-triazolate, 1,2,3-triazolate, tetrazolate, pyrazolate, or an organic conjugate base derived from (with one or more nitro substituents):

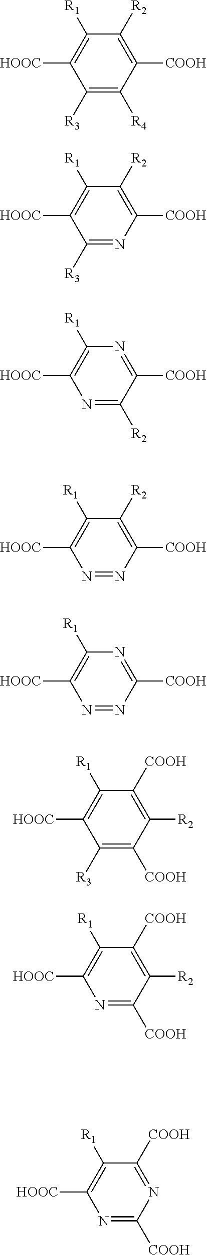

The organic linker may be an azolate linking moiety. The organic linker has one, two, three or more nitro substituents. For instance, when the organic linker is imidazolate, the nitro substituent may be at the 2-position, the 4-position, the 5-position, or any combination thereof.

The organic linker may have one or more other substitutions, such as one or more of H, lower alkyl, oxyalkyl, aryl, heteroaryl, heterocycloalkyl, aminoalkyl and a halogen.

The metal cations may be, for instance, one or more of Co²⁺, Zn²⁺, Cd²⁺, Fe²⁺, Ni²⁺, Ag²⁺ and Cu²⁺. In some embodiments, the metal cation is Zn²⁺. In some embodiments, the metal cation is Cu²⁺. In some embodiments, the metal cation may be Co²⁺. In some embodiments, the metal cation may be Cd²⁺. In some embodiments, the metal cations used in the MOF may be the same, or may be a combination of different metal cations.

In some examples, the MOF material may be provided with a combustible substance (e.g. contained in the pores of the MOF material, or separate thereto). In some embodiments, the combustible substance may be a metal or metalloid powder. The metal or metalloid powder may be the metal or metalloid powder may be selected from at least one of Al(0), Mg(0), Zn(0), Zr(0), Ti(0), W(0), B(0) and Si(0).

In some embodiments, the combustible substance may be an inorganic compound. The inorganic substance may be a compound selected from at least one of the groups consisting of boranes, decaborate anions, hydrides, sulfides, hydrazine, hydrazine derivatives, inorganic salts, and peroxides. In some embodiments, the combustible substance may be an inorganic compound selected from the group consisting of borane derivatives hydrazine derivatives, and aluminum hydrides.

In some embodiments, the combustible substance may be an organic compound. The organic compound may have at least one functional group selected from the group consisting of cyano, nitro, amino, alkyl, alkynyl, butadienyl, phenyl, halides, hydroxyl, carbonyl, peroxy, acetylene, ethylene and vinyl. In some embodiments, the organic compound may be selected from the group consisting of paraffin, kerosene and nitroglycerin.

In some embodiments, the combustible substance may be a polymeric compound. In some examples, the polymeric compound may be selected from one or more of the groups consisting of polyesters, polysulfides, polyurethanes, resins, nitrates, and rubbers. In some embodiments, the polymeric compound may be one or more compounds selected from the group consisting of hydroxyl-terminated polybutadiene, polyethylene, polystyrene and polybutadiene acrylonitrile.

In some embodiments, the compound may include along with the MOF an additive that serves as a catalyst or initiator. The additive may be located in the pores of the MOF, or may be provided separate from the MOF. The composition may include, along with the MOF material, one or more additives, and/or one or more combustible substances. An exemplary weight ratio between the MOF material, the one or more additives, and the one or more combustible substances may be 10:75:15. An exemplary weight ratio between the MOF material, the one or more additives, and the one or more combustible substances may be 20:60:20. An exemplary weight ratio between the MOF material, the one or more additives, and the one or more combustible substances may be 30:55:15.

In some examples, the additive is one or more metals. Exemplary metals includes one or more of Ti(0), Al(0), Pd(0), and Zr(0). In some examples, the additive may be one or more inorganic compounds. In some embodiments, the one or more inorganic compounds acting as the additive may be selected from the group consisting of hydrides, azides, cyanamides, nitrates, acetates, sulfates, perchlorates, peroxides, oxides, and picrates. In some embodiments, the one or more inorganic compounds acting as the additive may be selected from the group consisting of ammonium nitrate, ammonium dinitramide, ammonium perchlorate, and aluminum borohydride.

The metal organic frameworks in accordance with the present teachings may be used as propellants for rockets, for fuelling a drilling system for deep-sea oil and gas extraction, for other under-water applications, etc.

The quantity of MOF material or a composition including the MOF material depends on the weight of the rocket or projectile (where fuels usually take up around ⅔ or more of the total mass of the rocket), the distance and/or height travelled, and the velocity sought for the projectile.

The MOF material or composition with the MOF material may be deposited in a propellant depot for fueling a spacecraft in space.

Metal Organic Framework Materials for Thrusting Rockets:

In the present disclosure, the use of the term “rocket” includes a missile.

The MOF material or the composition based thereon may be used by a rocket engine of chemical rockets (using exothermic reduction-oxidation chemical reactions) to form a high-speed propulsive jet of fluid (e.g. high temperature gas resulting from the combustion of the MOF materials, and, optionally, any other composition found in the mixture). As an oxidizer may be provided with the MOF material, the MOF material or composition based thereon may be used with rocket vehicles (e.g. used to propel spacecrafts and/or ballistic missiles).

For a chemical rocket, the fuel may be present in a first chamber or in a space defined by a body of the rocket itself. In some examples, an oxidizer may be present in a second chamber. However, in some embodiments, when the propellant is solid, an igniter causes the combustion of the solid propellant. The solid propellant defines a channel within the rocket, acting as a combustion chamber. The combusted gases exits the rocket, causing thrust.

When thrust is desired, the MOF material or the composition based thereon is mixed with the oxidizer in a combustion chamber. The fuel is ignited and thrust is produced by the expulsion of extremely hot combustion products, mostly gases, from the exit nozzle. The efficiency of the fuel at producing thrust is highly dependent on its chemical composition. Combustibles, additives, and oxidizers that burn in a highly exothermic manner and produce gaseous, monoatomic (light) combustion products are advantageous. Varying the composition of the fuel with strategically selected components can allow the optimization of fuel efficiency for the rocket. It has been suggested in the prior art that MOFs can be used to enhance the properties of certain oxidizers for solid rocket fuel formulations. Most MOFs, however, are not energetic, are very high in carbon, and will produce heavier combustion products. This leads to a lack of efficiency and less thrust per unit fuel burned. This disclosure presents, for the first time, the design and use of MOFs that are not only energetic but that have been selected for their nitro-containing building blocks that maximize the amount of light, gaseous combustion products that are released when the MOFs are burned. Due to the highly exothermic nature of the MOF material including the nitro-substituents of the organic linker, the expelled gases resulting from the combustion are at a very high temperature, thereby improving the thrust generated by the rocket through combustion of the MOF material. The result is that the

MOF material-based fuels/propellants increase the specific impulse per unit of propellant/fuel.

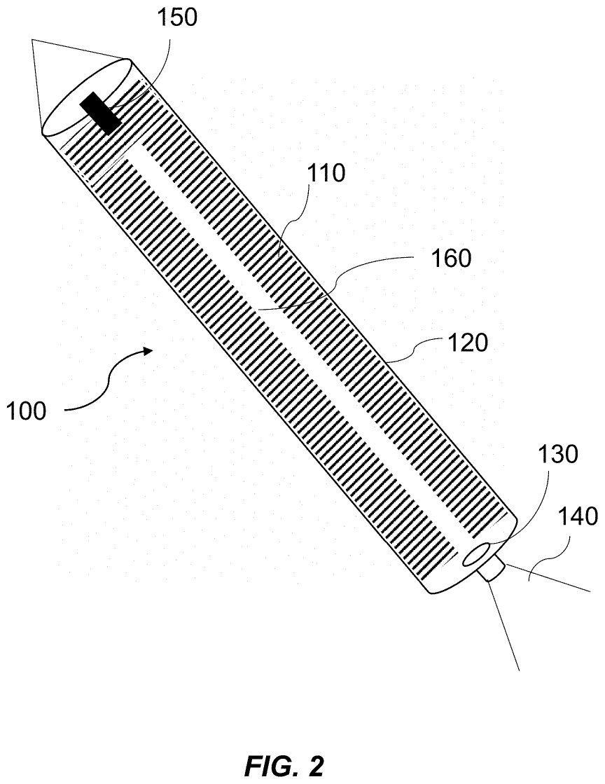

For instance, reference is made to FIG. 2, illustrating an exemplary rocket 100. It will be understood that other rockets, as are known in the art, may be adapted to receive the fuel and/or propellant in accordance with the present embodiments, without departing from the present teachings.

The rocket 100 includes a hollow elongated body 120 adapted to receive the propellant or fuel 110. The fuel or propellant 110 may be contained in a first chamber within the hollow body 120, with an oxidizer present in a second container in the hollow body 120. A third chamber, a combustion chamber, may be provided, receiving both the fuel/propellant 110 and the oxidizer for combustion of the fuel/propellant 110.

In other examples, as illustrated in FIG. 2, the propellant 110 may be contained in the cavity defined by the hollow body 120 of the rocket 100.

The hollow body 120 includes an exit point 130 for allowing the combustion fluids, produced by combusting the fuel or propellant 110, from exiting the hollow body 120 and entering the propelling nozzle 140. The location of the exit point 130 on the hollow body 120, shown in FIG. 2, is but for illustrative purposes, and may vary depending on the structure and/or use of the rocket.

The rocket 100 includes an ignition source 150 and a propelling nozzle 140.

The propelling nozzle 140 expands and accelerates the combustion fluids to increase the thrust caused by combustion of the propellant/fuel 110. Exemplary propelling nozzles include, but are not limited to, a de Laval nozzle, plug nozzle, aerospike nozzle, etc.

The ignition source 150 causes the propellant/fuel 110 to ignite. Exemplary ignition sources 150 may be a spark generator, an actuator for causing a mechanical force, etc.

The fuel/propellant 110 includes the MOF material as defined herein, or a composition with the MOF material as defined herein. As shown in FIG. 2, the MOF material or composition containing the MOF material may be positioned along the walls within the hollow body 120, and define a hollow channel 160 that acts as a combustion chamber. This channel 160 receives the combustion fluid produced through the combustion of the fuel/propellant 110 when ignited by the ignition source 150. This hollow channel 160 channels the produced combustion fluids to the exit point 130, where they exit the hollow body 120 through the exit point 130 and enter the propelling nozzle 140.

Definitions:

The term “additive” as used herein refers to a substance or composition that either accelerates the reaction, initiates the reaction, or enhances the combustion of the reaction. For instance, an additive can be a catalyst or an initiator. Exemplary additives may include hydrides, azides, cyanamides, nitrates, acetates, sulfates, perchlorates, peroxides, oxides and picrates.

The term “aminoalkyl” as used herein refers to a C1-C6 linear or branched alkyl joined to an amino group (NH₂). Examples of aminoalkyl include, but are not limited to, —CH₂NH₂, —CH₂CH₂NH₂, etc. An aminoalkyl may be optionally substituted with one to five substituents independently selected from, for instance, the group consisting of hydroxy, thiol, cyano, nitro, loweralkyl, sulfonyl, halogen or amino.

The term “bridging linker” as used herein refers to a polyatomic or monoatomic ligand used by design to connect two or more metal ions or clusters, the combination of which form the structure of the metal-organic framework.

The term “combustible substance” as used herein refers to a substance that can be added to a composition including the ignitable metal-organic framework that can undergo combustion with the ignitable metal-organic framework.

The term “aryl” as used herein refers to a six to ten membered monocyclic or polycyclic aromatic ring where all of the ring atoms are carbon atoms. Examples of aryls include but are not limited to phenyl and biphenyl. An aryl may be optionally substituted with one to five substituents independently selected from, for instance, the group consisting of hydroxy, thiol, cyano, nitro, loweralkyl, sulfonyl, halogen or amino.

The term “cycloalkyl” as used herein, refers to a three to ten membered monocyclic or polycyclic ring, saturated or partially unsaturated, where all of the ring atoms are carbon. Examples of cycloalkyl include, but are not limited to, cyclopropyl, cyclobutyl, cyclopentyl, cyclopentenyl, cyclohexyl, cyclohexenyl, etc. A cycloalkyl may be optionally substituted by one to five substituents independently selected from, for instance, the group consisting of hydroxy, thiol, cyano, nitro, loweralkyl, sulfonyl, halogen or amino.

The term “guest” as used herein refers to a substance present in or enclosed by the pore(s) of the metal organic framework. Exemplary guests include, but are not limited to, one or more of oxidizers, metal, metalloid particles (one or more of Al(0), Mg(0), Zn(0), Zr(0), B(0),and Si(0)), an inorganic compound such as hydrides, borohydrides, azides, amides, dinitramides, cyanamides, nitrates, acetates, sulfates, perchlorates, peroxides, oxides, borides, carbides, and picrates, an inorganic compound such as ammonium nitrate, ammonium dinitramide, ammonium perchlorate, or aluminum borohydride, an organic compound such as an organic compound with with at least one functional group selected cyano, nitro, amino, alkyl, allyl, vinyl, alkenyl, alkynyl, butadienyl, phenyl, halides, hydroxyl, carbonyl, peroxy and acetylene, an organic compound that is selected from paraffin, kerosene and nitroglycerin. The guest may be an additive or combustible substance.

The term “heteroaryl” as used herein refers to a five to ten membered monocyclic or polycyclic aromatic ring having atoms selected from N, O, S and C. Examples of heteroaryl include, but are not limited to, furanyl, thienyl, imidazolyl, pyrazolyl, pyrrolyl, pyrrolinyl, thiazolyl, etc. An heteroaryl may be optionally substituted with one to five substituents independently selected from, for instance, the group consisting of hydroxy, thiol, cyano, nitro, loweralkyl, sulfonyl, halogen or amino.

The term “heterocycloalkyl” as used herein refers to a four to ten membered monocyclic or polycyclic ring, saturated or partially unsaturated, where the ring atoms are selected from N, O, S and C. Examples of heterocycloalkyl include, but are not limited to, azetidinyl, tetrahydrofuran, dihydrofuran, dioxane, morpholine, etc. A heterocycloalkyl may be optionally substituted by one to five substituents independently selected from, for instance, the group consisting of hydroxy, thiol, cyano, nitro, loweralkyl, sulfonyl, halogen or amino.

The term a “metal organic framework” or “metal organic framework material” as used herein refers to a class of a of compounds known as coordination polymers or coordination networks. The metal organic framework has metal ions coordinated to organic linkers or ligands to form one-, two- or three-dimensional structures. The metal organic frameworks as described herein may be of different types, such as UiO-type (Universitetet i Oslo), pillared-type, MIL-type or MIL-53 (Matériaux de l′Institut Lavoisier), isoreticular-type, MOF-74-type, HKUST-type (Hong Kong University of Science and Technology), etc.

The term “loweralkoxy” or “oxyalkyl” as used herein, refers to C1-C6 linear or branched alkoxy, such as methoxy, ethoxy, propyloxy, butyloxy, isopropyloxy, and t-butyloxy. A loweralkoxy or oxyalkyl may be optionally substituted with one to five substituents independently selected from, for instance, the group consisting of hydroxy, thiol, cyano, nitro, loweralkyl, sulfonyl, halogen or amino.

The term “loweralkyl,” as used herein, refers to C1-C6 linear or branched alkyl, such as methyl, ethyl, propyl, butyl, isobutyl, isopropyl, sec-butyl, tert-butyl, pentyl, isopentyl, and hexyl. A loweralkyl may be optionally substituted with one to five substituents independently selected from, for instance, the group consisting of hydroxy, thiol, cyano, nitro, loweralkyl, sulfonyl, halogen or amino.

The term “metal cluster” as used herein refers to a unit of two or more metal ions and any number of additional atoms that form nodes that, when connected by bridging linkers, yield the structure of the metal-organic framework.

The term “nitro” as used herein refers to a functional group such as nitro, nitromethyl, nitromethylene, nitroethyl, nitroethene, 1-nitropropyl, 2-nitrpropyl, 1-nitropropylene, 2-nitropropylene, nitrate ester, and other related substituents containing the nitro (—NO₂) group.

The term “organic linker” as used herein refers to an organic molecule that is coordinated with metal cations to form metal-organic frameworks. Exemplary organic linkers include but are not limited to azolates, terephthalates, trimesates, benzoates.

The term an “oxidizer”, “oxidant” or “oxidizing agent” as used herein refers to a substance that is able to oxidize other substances, causing them to lose electrons. Exemplary oxidizers include, but are not limited to, peroxides (such as hydrogen peroxide), nitric acid, nitrate compounds, sulfuric acid, halogen compounds, sodium perborate, hexavalent chromium compounds, peroxydisulfuric acid, peroxymonosulfuric acid, chlorite, chlorate, perchlorate, oxygen (such as liquid oxygen), ozone, etc.

The term “paddlewheel type metal unit” as used herein refers to a metal-organic-framework building block known as a node, comprising a metal dimer that, when connected to four carboxylic acid-based bridging linkers, takes on a general structure that resembles that of a paddlewheel.

The term “pillaring linker” has used herein refers to any ditopic (two-connecting) ligand that, by joining together 2-dimensional layers of ligands and metal ions or clusters by linking together the metal ions or clusters, forms the structure of a 3-dimensional metal-organic framework.

The term “pore” or “pocket” is used interchangeably herein to define a space or pocket created by the structure of the metal organic framework.

Exemplary Studies:

The following exemplary studies are provided to enable the skilled person to better understand the present disclosure. As they are but illustrative and representative examples, they should not limit the scope of the present disclosure, only added for illustrative and representative purposes. It will be understood that other exemplary studies may be used to further illustrate and represent the present disclosure without departing from the present teachings.

Exemplary Study 1:

An exemplary method of synthesizing an exemplary MOF in accordance with the present disclosure was performed.

An exemplary metal organic framework is synthesized by mixing a solution of 0.298 g Zn(NO₃)₂·6H₂O in 25 mL methanol solvent with a solution of 0.226 g 4-nitroimidazole in 25 mL methanol solvent and stirring for 30 minutes at room temperature. The white precipitate is filtered over vacuum, washed three times with fresh methanol, and dried in a vacuum oven at 85° C. overnight. The resulting material is a material Zn(4Nlm)₂. This procedure can be conducted with 2-nitroimidazole to yield a yield a material Zn(2Nlm)₂, which can be a sodalite-topology (SOD) material also known as ZIF-65.

Exemplary Study 2:

Formation enthalpy of the compounds was then measured.

SOD-Zn(2Nlm)₂ was exposed to a flame to attempt to start combustion. For comparison purposes, a same compound where the linking moiety does not have a nitro-substituent was used: SOD-Zn(Melm)₂. Both compounds demonstrate very different formation enthalpy values. The results of the isostructural formation enthalpy were presented in Table 1.

TABLE 1
formation enthalpy of the MOFs
when exposed to a flame.

| | Formation |
|---|---|
| | Enthalpy |
| Compound | (kJ/mol) |
| SOD-Zn(2Nlm)₂ | 2538 kJ/mol |
| SOD-Zn(Melm)₂ | −248 kJ/mol |

When exposed to open flame, both materials (first material with the nitro-group at the 2-position of the linking moiety; second material with the nitro group at the 4-position of the linking moiety) have the unique property of igniting and combusting. SOD-Zn(2Nlm)₂ has a calculated formation enthalpy of 2538 kJ/mol. As a comparison, the formation enthalpy of the isostructural material made with 2-methylimidazole, SOD-Zn(Melm)₂, is not ignitable and has a calculated formation enthalpy of −248 kJ/mol.

These results demonstrate the significant energy advantage of replacing a methyl group with a nitro group in the MOF. The results show that providing a linking moiety with a nitro-substituent is more exothermic than one with a methyl group. It will there be sound to extrapolate that increasing the number of nitro-substitutes may maintain, if not increase, the formation enthalpy during combustion of the MOF. Moreover, other linking moieties that are known in the literature may be altered to add one or more nitro-substituents in order to yield a MOF that can ignite. Exemplary linking moieties that may be used instead of imidazolate include, but are not limited to, 1,2,4-triazolate, 1,2,3-triazolate, tetrazolate or pyrazolate.

Furthermore, it may be concluded that substituting Zn²⁺ with an equivalent metal cation such as Co²⁺, Cd²⁺, Fe²⁺, Ni²⁺, Ag²⁺ or Cu²⁺, may also yield an ignitable

MOF, as the elevated formation enthalpy appears to be attributable to the nitro-substituent of the linking moiety and less to the choice of cation.

Additionally, by substituting the methyl group (or any other carbon substituent) with a nitro-group, the exhaust products contain less CO₂ and more N₂, thereby increasing the energy released upon combustion of the fuel.

Although the invention has been described with reference to preferred embodiments, it is to be understood that modifications may be resorted to as will be apparent to those skilled in the art. Such modifications and variations are to be considered within the purview and scope of the present invention.

Representative, non-limiting examples of the present invention were described above in detail with reference to the attached drawing. This detailed description is merely intended to teach a person of skill in the art further details for practicing preferred aspects of the present teachings and is not intended to limit the scope of the invention. Furthermore, each of the additional features and teachings disclosed above and below may be utilized separately or in conjunction with other features and teachings.

Moreover, combinations of features and steps disclosed in the above detailed description, as well as in the experimental examples, may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

What is claimed is:

1. An ignitable and energetic metal-organic framework material for producing a fuel when exposed to an ignition source, comprising a general structure M1-L-M2, wherein L is an organic azolate linking moiety, and wherein M1 and M2 are same or different divalent metal cations.

2. The ignitable metal-organic framework material as defined in claim 1, wherein M1 and M2 are each selected from the group consisting of Co²⁺, Zn²⁺, Cd²⁺, Fe²⁺, Ni²⁺, Ag²⁺ and Cu²⁺.

3. The ignitable metal-organic framework material as defined in claim 2, wherein M1 and M2 are each Co²⁺.

4. The ignitable metal-organic framework material as defined in claim 2, wherein M1 and M2 are each Zn²⁺.

5. The ignitable metal-organic framework material as defined in claim 1, wherein said organic azolate linking moiety is selected from the group consisting of imidazolate, 1,2,4-triazolate, 1,2,3-triazolate, tetrazolate and pyrazolate.

6. The ignitable metal-organic framework material as defined in claim 5, wherein said organic azolate linking moiety is imidazolate.

7. The ignitable metal-organic framework material as defined in claim 5, wherein said organic azolate linking moiety is benzimidazolate, wherein the benzimidazolate is unsubstituted, substituted at the 2-position or in one or more of the phenyl rings.

8. The ignitable metal-organic framework material as defined in claim 5, wherein said organic azolate linking moiety is 1,2,3-triazolate that is unsubstituted or substituted in one or more of the 4- and 5-positions.

9. The ignitable metal-organic framework material as defined in claim 5, wherein said organic azolate linking moiety is 1,2,4-triazolate that is unsubstituted or substituted in one or more of the 3- and 5-positions.

10. The ignitable metal-organic framework material as defined in as defined in claim 5, wherein the organic azolate linking moiety is tetrazolate that is unsubstituted or substituted in the 5-position.

11. The ignitable metal-organic framework material as defined in claim 1, wherein the general structure of the metal-organic framework material is Zn(Nlm)₂, Co(Nim)₂, Cd(Nim)₂, Zn(diNlm)₂, Co(diNim)₂, Cd(diNim)₂, Zn(triNlm)₂, Co(triNim)₂, or Cd(triNim)₂.

12. A combustible composition comprising the ignitable metal-organic framework material as defined in claim 1, a combustible substance and an additive, wherein the metal-organic framework material is for producing a fuel when ignited upon contact with an ignition source.

13. The combustible composition as defined in claim 12, wherein the combustible substance is an inorganic compound selected from the group consisting of decaborane, hydrazine and aluminum hydride.

14. The combustible composition as defined in claim 12, wherein the combustible substance is an organic compound selected from the group consisting of paraffin, kerosene and nitroglycerin.

15. The combustible composition as defined in claim 12, wherein the polymeric compound is selected from one or more of the groups consisting of polyesters, polysulfides, polyurethanes, resins, nitrates, and rubbers.

16. The combustible composition as defined in claim 12, wherein the one or more inorganic compounds acting as the additive are selected from the group consisting of ammonium nitrate, ammonium dinitramide, ammonium perchlorate, and aluminum borohydride.

17. A method of propelling a missile or rocket comprising:
combusting the metal organic framework material as defined in claim 1 through exposure to an ignition source,
wherein the combusted metal organic framework produces nitrogen dioxide as a combustion by-product.

18. A method of fuelling a drilling system for deep-sea oil and gas extraction, comprising:
combusting the metal organic framework material as defined in claim 1 through exposure to an ignition source, the metal-organic framework material comprising a general structure M1-L-M2, wherein L is an aromatic linker comprising one or more nitro substituents, and wherein M1 and M2 are same or different metal cations,
wherein the combusted metal organic framework drives the drilling system for deep-sea oil and gas extraction.

19. A rocket comprising:
an elongated hollow body with an exit point for allowing heated combustion fluid to exit the hollow body;
a propelling nozzle joined to the exit point, where the combustion fluid flows from the elongated hollow body to the propelling nozzle through the exit point, for expanding and accelerating the combustion gases, for creating a thrust for the rocket;
the metal-organic framework material as defined in claim 1, contained in the elongated hollow body; and
an ignition source for igniting the metal-organic framework material.

20. A propellant for fuelling a drilling system for deep-sea oil and gas extraction or for propelling a rocket, comprising the metal-organic framework material as defined in claim 1.
